(19) United States
(12) Patent Application Publication
(10) Pub. No.: US 2026/0321283 A1
(43) Pub. Date: Oct. 15, 2026

(54) SUSPENSION ASSEMBLY AND DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Yusuke NOJIMA, Yokohama Kanagawa (JP); Kenichiro AOKI, Machida Tokyo (JP)

(21) Appl. No.: 19/251,350

(22) Filed: Jun. 26, 2025

(30) Foreign Application Priority Data
Apr. 10, 2025 (JP) 2025-065150

(51) Int. Cl. G11B 5/48

(52) U.S. Cl. CPC G11B 5/4853

(57) ABSTRACT

A suspension assembly according to one embodiment includes a tail joint. The tail joint includes a base layer, a cover layer, a conductive layer between the base layer and the cover layer, and a first groove between a first cover-layer part and a second cover-layer part of the cover layer. The conductive layer has joint terminals, each of which extends across the first groove. Each of the joint terminals includes a first edge and a second edge. The first edge includes a first straight edge and a first recessed edge recessed from the first straight edge. The second edge includes a second straight edge and a second recessed edge that is recessed from the second straight edge and that is closer to the first cover portion than the first recessed edge is and farther from the second cover portion than the first recessed edge is.

### CROSS-REFERENCE TO RELATED APPLICATIONS

This application is based upon and claims the benefit of priority from Japanese Patent Application No. 2025-065150, filed on Apr. 10, 2025; the entire contents of which are incorporated herein by reference.

### FIELD

Embodiments described herein relate generally to a suspension assembly and a disk device.

### BACKGROUND

A disk device, such as a hard disk drive (HDD), generally includes a plurality of magnetic disks; a plurality of suspension assemblies; and a substrate such as a flexible printed circuit board (FPC). Each of the plurality of suspension assemblies includes a wiring member such as a flexure; and magnetic heads that are mounted on the wiring member to reads/write information from/to corresponding magnetic disks.

The wiring member includes a plurality of joint terminals such as flying leads. The plurality of joint terminals are in the form of, for example, a simply supported beam traversing a groove and are arranged side by side along the groove. The joint terminals are soldered to respective pads on the board.

Each joint terminal may be provided with a hole or a plurality of recesses. Such a narrower joint terminal with a hole or a plurality of recesses may lower in durability.

### BRIEF DESCRIPTION OF THE DRAWINGS

FIG. 1 is an exemplary exploded perspective view illustrating an HDD according to a first embodiment.

FIG. 2 is an exemplary plan view illustrating an HGA in the first embodiment.

FIG. 3 is an exemplary plan view schematically illustrating a carriage, an FPC, and portions of flexures in the first embodiment.

FIG. 4 is an exemplary plan view illustrating a tail joint in the first embodiment.

FIG. 5 is an exemplary plan view illustrating a portion of the tail joint in the first embodiment.

FIG. 6 is an exemplary cross-sectional view illustrating the tail joint in the first embodiment taken along line F6-F6 of FIG. 5.

FIG. 7 is an exemplary cross-sectional view illustrating the tail joint and the joint in the first embodiment taken along line F7-F7 in FIG. 5.

FIG. 8 is an exemplary plan view illustrating a portion of a tail joint according to a second embodiment.

FIG. 9 is an exemplary plan view illustrating a portion of a tail joint according to a third embodiment.

### DETAILED DESCRIPTION

According to one embodiment, a suspension assembly includes a magnetic head and a wiring member. The wiring member includes a mount on which the magnetic head is mounted, and a tail joint electrically connected to the mount. The tail joint includes a base layer having an insulating property, a cover layer having an insulating property, a conductive layer disposed between the base layer and the cover layer, and a backing layer attached to the base layer. The cover layer includes a first cover-layer part, a second cover-layer part being apart from the first cover-layer part, and a first groove extending between the first cover-layer part and the second cover-layer part. The conductive layer includes a plurality of joint terminals which are arranged at intervals and each of which extends across the first groove between the first cover-layer part and the second cover-layer part. Each of the plurality of joint terminals includes a first edge that faces an adjacent one of the plurality of joint terminals, and a second edge being opposite to the first edge. The first edge includes a first straight edge that extends linearly, and a first recessed edge that is recessed from the first straight edge. the second edge includes a second straight edge that extends linearly, and a second recessed edge that is recessed from the second straight edge. The second recessed edge is closer to the first cover-layer part than the first recessed edge is, and is farther from the second cover-layer part than the first recessed edge is.

### First Embodiment

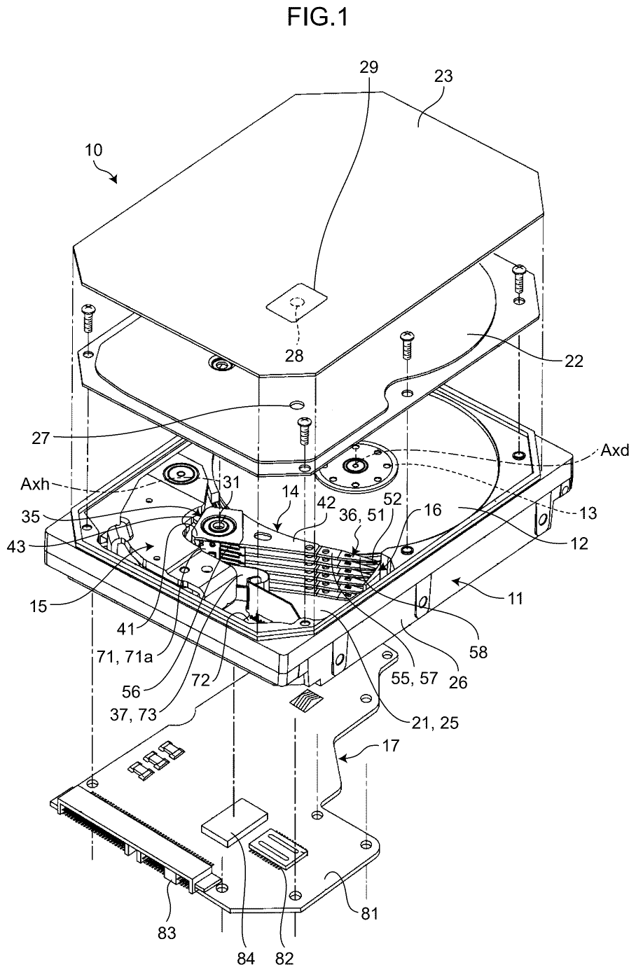

A first embodiment will be described below with reference to FIGS. 1 to 7. It should be noted that herein components according to embodiments and explanations of such components are sometimes described in plural expressions. Components and the explanations thereof are examples and not limited by the expressions used herein. Components may also be identified with different names from those used herein. In addition, components may be explained by different expressions from the expressions used herein.

The “prevent” described hereinafter is defined, for example, as preventing an occurrence of an event, action, or influence or as reducing the degree of such an event, action, or influence. Furthermore, the “restrict” described hereinafter is defined, for example, as preventing movement or rotation or as permitting movement or rotation within a predetermined range but preventing movement or rotation beyond the predetermined range.

FIG. 1 is an exemplary exploded perspective view illustrating a hard disk drive (HDD) 10 according to a first embodiment. The HDD 10 is an example of a disk device and may also be referred to as an electronic apparatus, a storage device, an external storage device, or a magnetic disk device.

As illustrated in FIG. 1, the HDD 10 includes a housing 11, a plurality of magnetic disks 12, a spindle motor 13, a head stack assembly (HSA) 14, a voice coil motor (VCM) 15, a ramp load mechanism 16, and a printed circuit board (PCB) 17. However, the HDD 10 is not limited to this example.

The housing 11 contains the magnetic disks 12, the spindle motor 13, the HSA 14, the VCM 15, and the ramp load mechanism 16. The housing 11 includes a base 21, an inner cover 22, and an outer cover 23.

The base 21 has a substantially rectangular box shape having an aperture that is open in one direction. The base 21 has a bottom wall 25 and a side wall 26. The bottom wall 25 has a substantially rectangular (quadrangular) tabular shape. The side wall 26 is erected from the side edges of the bottom wall 25 and has a substantially rectangular frame shape.

The inner cover 22 is attached to the upper edge of the side wall 26 with screws, for example, thereby sealing the inner space of the base 21. The outer cover 23, which covers the inner cover 22, is attached to the upper edge of the side wall 26 with welding, for example. The inner cover 22 is provided with a vent 27. In addition, the outer cover 23 is provided with a vent 28.

Via both the vents 27 and 28, air is purged from the interior of the housing 11, after both the inner cover 22 and the outer cover 23 have been attached to the base 21 in which some components are mounted. The housing 11 is then filled with a gas, which is different from air.

Examples of the gas to be filled inside the housing 11 include: a low-density gas, the density of which is lower than that of air; and an inert gas having low reactivity. For example, the housing 11 is filled with helium. Alternatively, the housing 11 may be filled with another fluid.

The vent 28 of the outer cover 23 is closed with a seal 29. The seal 29 hermetically seals the vent 28, thereby restricting the fluid filled inside the housing 11 from leaking to the outside via the vent 28.

Each of the plurality of magnetic disks 12 is substantially round and flat. At least one of both surfaces of each magnetic disk 12 is provided with a magnetic recording layer. The plurality of magnetic disks 12 are stacked on the top of one another with predetermined spacing therebetween.

The spindle motor 13 supports the plurality of magnetic disks 12. The spindle motor 13 rotates the plurality of magnetic disks 12 around an axis Axd of the spindle motor 13. The plurality of magnetic disks 12 are held on a hub of the spindle motor 13 by a clamp spring, for example.

The HSA 14 is rotatably supported by a support shaft 31. The support shaft 31 is provided at a location apart from the magnetic disks 12 in a direction orthogonal to the axis Axd. The support shaft 31 protrudes from the bottom wall 25 of the housing 11.

The HSA 14 is rotatable around an axis Axh. The axis Axh is a virtual axis that extends in substantially parallel with the axis Axd of the magnetic disks 12. The axis Axh corresponds to, for example, the rotational center of the HSA 14 as well as the axis of the support shaft 31.

The HSA 14 includes a carriage 35, a plurality of head gimbal assemblies (HGAs) 36, and a flexible printed circuit board (FPC) 37. Each HGA 36 is an example of a suspension assembly and may also be referred to as a head suspension. The FPC 37 is an example of a board.

The carriage 35 is made of a metal, for example. The carriage 35 includes an actuator block 41, a plurality of arms 42, and a frame 43.

The actuator block 41 is rotatably supported by the support shaft 31 via a bearing, for example. The plurality of arms 42 protrude from the actuator block 41 in a direction substantially orthogonal to the axis Axh. In this case, the carriage 35 may be divided into a plurality of parts, and the arms 42 may protrude from respective actuator blocks 41.

The plurality of arms 42 extend in substantially parallel and are arranged at predetermined spacing along the axis Axh. The arms 42 of a tabular shape can enter the respective gaps between two adjacent pairs of the plurality of magnetic disks 12.

The frame 43 protrudes from the actuator block 41 and is positioned on opposite side of the arms 42. The frame 43 is attached to a voice coil of the VCM 15. The VCM 15 includes the voice coil, a pair of yokes, and a magnet provided on the yokes.

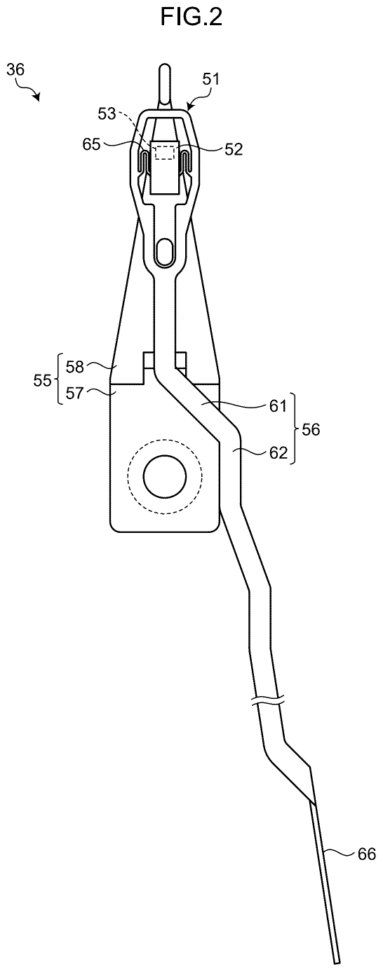

FIG. 2 is an exemplary plan view illustrating an HGA 36 in the first embodiment. The plurality of HGA 36 are attached to respective tip ends of the plurality of arms 42. The plurality of HGAs 36 are thereby arranged at predetermined spacing along the axis Axh. As illustrated in FIG. 2, each of the plurality of HGAs 36 includes a suspension 51, a magnetic head 52, and a laser diode unit (LDU) 53. The magnetic head 52 may also be referred to as the slider.

The suspension 51 supports the magnetic head 52. The suspension 51 includes a support plate 55 and a flexure 56. The flexure 56 is an example of a wiring member. The support plate 55 has a base plate 57 and a load beam 58. However, the support plate 55 is not limited to this example and may be a single independent member, for example.

The base plate 57 has a tabular shape and is attached to a tip end of a corresponding arm 42. The load beam 58 has a tabular shape and is thinner than the base plate 57. The load beam 58 is attached to the base plate 57 in such a way that the load beam 58 protrudes from the base plate 57.

The flexure 56 is a type of flexible printed wiring board and has an elongated belt shape. The flexure 56 has, for example, a front part 61 and a rear part 62. It should be noted that the front part 61 and the rear part 62 are designations for convenience and are not intended to limit a position, direction, and usage mode thereof.

The front part 61 is disposed on the support plate 55. For example, the front part 61 is attached at a plurality of locations to the support plate 55 with spot welding. The front part 61 has a gimbal 65. The gimbal 65 is an example of a mount.

The gimbal 65 is located at one end of the flexure 56. Both the magnetic head 52 and the LDU 53 are mounted on the gimbal 65. The gimbal 65 is attached to the load beam 58 in such a way that the magnetic head 52 is rotatable.

The rear part 62 extends along the arms 42 from the front part 61 towards the actuator block 41. The rear part 62 is spaced apart from the support plate 55. The rear part 62 has a tail joint 66. The tail joint 66 is located at the other end of the flexure 56 and is electrically connected to the gimbal 65.

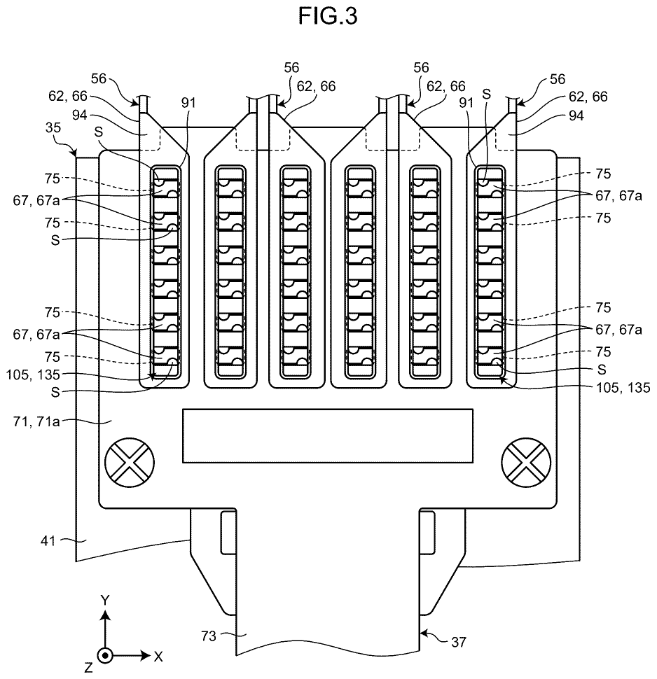

FIG. 3 is an exemplary plan view schematically illustrating the carriage 35, the FPC 37, and portions of flexures 56 according to the first embodiment. As illustrated in FIG. 3, each tail joint 66 has a band shape and has a plurality of joint terminals 67. Each joint terminal 67 may also be referred to as the electrode.

As illustrated in FIG. 1, the FPC 37 has a band shape, for example. The FPC 37 includes two joints 71 and 72 and a flexible portion 73. The joint 71 is provided at one end of the FPC 37 and attached to the actuator block 41. The joint 72 is provided at the other end of the FPC 37 and attached to the bottom wall 25 of the base 21. The flexible portion 73 is provided between the joint 71 and the joint 72 and elastically bent with the rotation of the HSA 14.

As illustrated in FIG. 3, the joint 71 has a surface 71a. The surface 71a is a substantially rectangular plane and is oriented, as a whole, in a direction substantially orthogonal to the axis Axh. However, the surface 71a is not limited to this example and may have irregularities or may be partly bent.

For convenience, an X-axis, a Y-axis, and a Z-axis are defined as follows. The X-axis, the Y-axis, and the Z-axis are orthogonal to one another. The X-axis is provided along the width of the surface 71a. The Y-axis is provided along the length of the surface 71a. The Z-axis is provided so as to be orthogonal to the surface 71a.

Herein, X directions, Y directions, and Z directions are also defined. The X directions are directions along the X-axis and include: a +X direction indicated by an arrow of the-X axis; and a −X direction opposite to the direction of the arrow of the X-axis. The Y directions are directions along the Y-axis and include: a +Y direction indicated by an arrow of the Y-axis; and a −Y direction opposite to the direction of the arrow of the Y-axis. The Z directions are directions along the Z-axis and include: a +Z direction indicated by an arrow of the Z-axis; and a −Z direction opposite to the direction of the arrow of the Z-axis. The surface 71a is oriented in the +Z direction.

The joint 71 is provided with a plurality of pads 75. Each pad 75 may also be referred to as the electrode or land. The plurality of pads 75 form a plurality of rows arranged in substantially the X directions. In each of the plurality of rows, a plurality of pads 75 are arrayed in substantially the Y directions. The number of rows formed by pads 75 is equal to the number of HGAs 36. The tail joints 66 of the HGAs 36 extend in substantially the Y directions along the rows of pads 75 and cover the respective rows of the pads 75.

The HGA 36 further includes a plurality of fillets of solder S. The plurality of fillets of solder S join the plurality of joint terminals 67 of the flexure 56 and the plurality of pads 75 of the FPC 37. The flexure 56 thereby electrically connects the FPC 37 to the magnetic heads 52.

The VCM 15 in FIG. 1 rotates the carriage 35 around the axis Axh. By rotating the carriage 35 around the axis Axh, the magnetic heads 52 are moved to desired locations on the respective magnetic disks 12.

Each magnetic head 52 includes: a read element that reproduces information from the recording layer of a corresponding magnetic disk 12; and a write element that records information on the recording layer. Each magnetic head 52 reads/writes information from/to a corresponding magnetic disk 12.

As illustrated in FIG. 2, the LDU 53 is attached to the magnetic head 52. Alternatively, the LDU 53 may be formed integrally with the magnetic head 52. The LDU 53 irradiates a corresponding magnetic disk 12 with laser light to heat the magnetic disk 12. This enables the HDD 10 to perform thermally assisted magnetic recording (HAMR). However, the LDU 53 may not be provided in the HDD 10.

When a magnetic head 52 moves to the outermost circumference of a corresponding magnetic disk 12 with the rotation of the carriage 35 by the VCM 15 illustrated in FIG. 1, the ramp load mechanism 16 holds the HGA 36. When the HGA 36 is held by the ramp load mechanism 16, the magnetic head 52 is spaced apart from the magnetic disk 12.

The PCB 17 is disposed outside the housing 11 and attached to the bottom wall 25 of the base 21. The PCB 17 includes, for example, a printed wiring board (PWB) 81, a relay connector 82, an interface (I/F) connector 83, and a controller 84.

The PWB 81 is, for example, a rigid board such as a glass epoxy board and is a multilayered board or a build-up board. The relay connector 82, the I/F connector 83, and the controller 84 are mounted on the PWB 81.

The relay connector 82 is electrically connected to the joint 72 of the FPC 37, for example, through a connector provided on the bottom wall 25 of the housing 11. The I/F connector 83 is connected to a host computer. The controller 84, which is an electronic component such as a system on a chip (SoC), controls the operation of the HDD 10.

The controller 84 is electrically connected to the magnetic heads 52 through the PWB 81, the relay connector 82, the FPC 37, and the flexure 56. The controller 84 causes the magnetic heads 52 to read/write information from or to the respective magnetic disks 12.

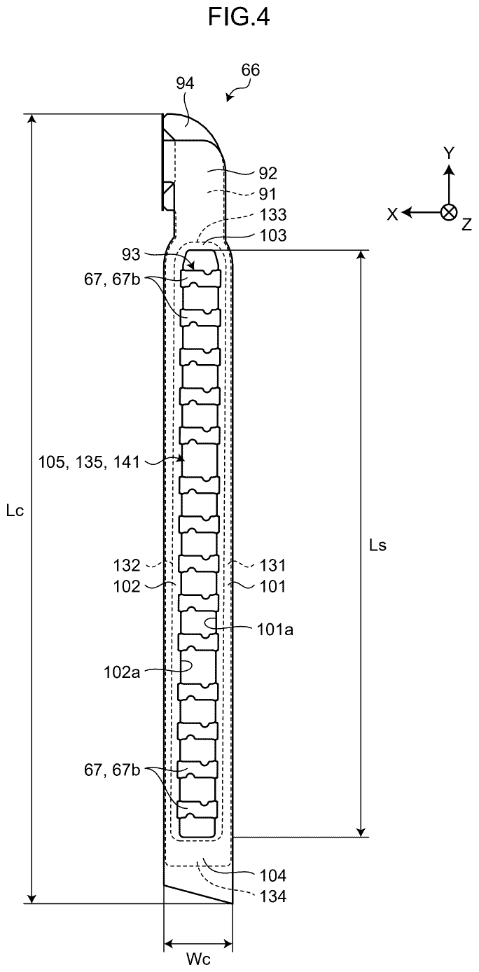

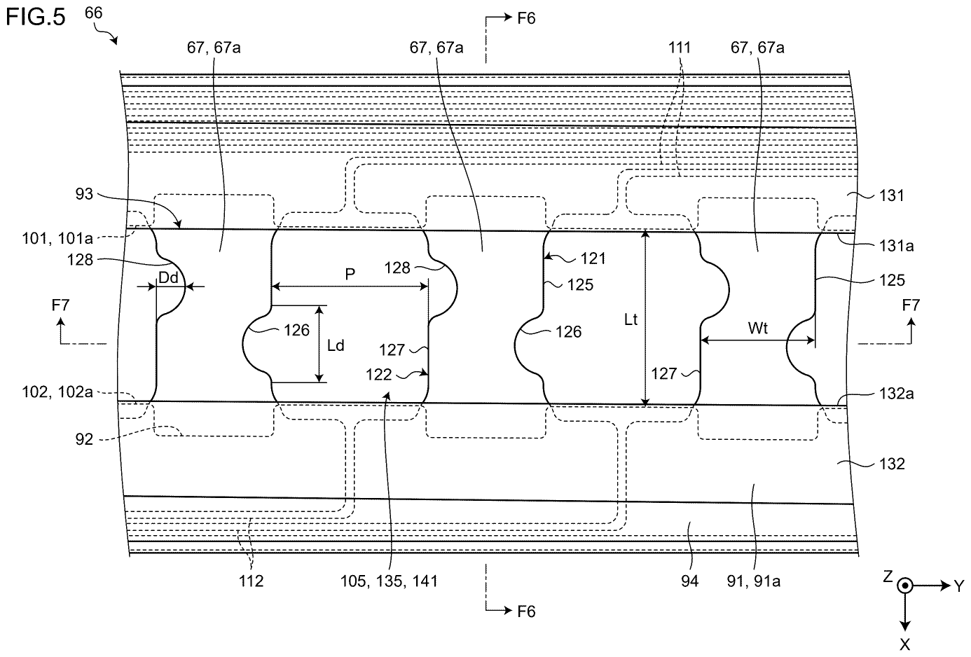

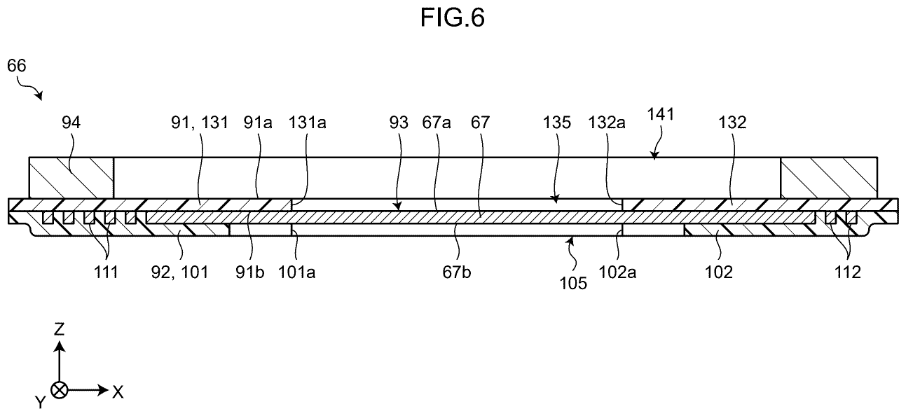

FIG. 4 is an exemplary plan view illustrating a tail joint 66 in the first embodiment. FIG. 5 is an exemplary plan view illustrating a portion of the tail joint 66 in the first embodiment. FIG. 6 is an exemplary cross-sectional view of the tail joint 66 in the first embodiment taken along line F6-F6 of FIG. 5.

As illustrated in FIG. 6, the flexure 56 includes a base layer 91, a cover layer 92, a conductive layer 93, and a backing layer 94. Thus, the tail joint 66, as a part of the flexure 56, also partly includes the base layer 91, the cover layer 92, the conductive layer 93, and the backing layer 94. The base layer 91 and the cover layer 92 may also be referred to as the insulating layers.

Each of the base layer 91 and the cover layer 92 is an insulating thin film made of polyimide (PI), for example. However, the base layer 91 and the cover layer 92 may be made of another material or may be made of mutually different materials.

Each of the base layer 91 and the cover layer 92 is translucent, for example. More specifically, each of the base layer 91 and the cover layer 92 is nontransparent or colored so as to be able to at least partly absorb visible light. The color of the base layer 91 and the cover layer 92 is not limited to this example.

In the tail joint 66, the base layer 91 has two surfaces 91a and 91b. The surface 91a is substantially flat and oriented in substantially the +Z direction as a whole. The surface 91b is opposite to the surface 91a. The surface 91b is substantially flat and oriented in substantially the −Z direction as a whole. The surface 91b of the base layer 91 and the surface 71a of the joint 71 face each other. The cover layer 92 covers the surface 91b of the base layer 91.

The conductive layer 93 is made of a metal, such as copper foil. The conductive layer 93 is provided on the surface 91b of the base layer 91. The conductive layer 93 is partly covered with the cover layer 92. In short, the conductive layer 93 is disposed between the base layer 91 and the cover layer 92.

The backing layer 94 is, for example, a metal plate made of stainless steel. However, the backing layer 94 is not limited to this example. The backing layer 94 is attached to the surface 91a of the base layer 91. The backing layer 94 is higher in rigidity than any of the base layer 91, the cover layer 92, and the conductive layer 93.

As illustrated in FIG. 4, the cover layer 92 at the tail joint 66 has a substantially rectangular frame shape. The cover layer 92 has two lateral parts 101 and 102 and two ends 103 and 104. The lateral part 101 is an example of a first cover. The lateral part 102 is an example of a second cover.

Each of the lateral parts 101 and 102 extends in substantially the Y directions. The lateral part 102 is apart from the lateral part 101 in the +X direction. The end 103 is connected to the +Y-directional ends of the lateral parts 101 and 102. The end 104 is connected to the −Y-directional ends of the lateral parts 101 and 102. The end 104 is thus apart from the end 103 in the −Y direction.

The cover layer 92 is provided with a cover groove 105. The cover groove 105 is an example of a first groove. The cover groove 105 is a through-hole passing the cover layer 92 in substantially the Z directions. However, the cover groove 105 is not limited to this example and may be a cutout, for example.

The cover groove 105 is defined by the lateral parts 101 and 102 and the ends 103 and 104, for example. The cover groove 105 is thus located between the two lateral parts 101 and 102 and between the two ends 103 and 104. The cover groove 105 extends in substantially the Y directions.

As illustrated in FIG. 5, the lateral part 101 has an edge 101a. The edge 101a is provided on the +X-directional side of the lateral part 101 and extends in substantially the Y directions. The lateral part 102 has an edge 102a. The edge 102a is provided on the −X-directional side of the lateral part 102 and extends in substantially the Y directions. Both the edge 101a and the edge 102a face each other to define the cover groove 105.

In the tail joint 66, the conductive layer 93 includes a plurality of wires 111, a plurality of wires 112, and the plurality of joint terminals 67. The wires 111 and 112 may also be referred to as the signal lines.

As illustrated in FIG. 6, each wire 111 is provided on the surface 91b of the base layer 91 and is disposed between the base layer 91 and the lateral part 101. In short, the wires 111 are disposed on the lateral part 101. The plurality of wires 111 extend in substantially parallel in the lateral part 101.

Each wire 111 extends between the lateral part 101 and the gimbal 65. At least one of the plurality of wires 111 is electrically connected to a corresponding magnetic head 52 via the gimbal 65. At least another one of the plurality of wires 111 is electrically connected to another component, such as the LDU 53 or a piezoelectric element. At least one of the plurality of wires 111 may be floating or may be electrically connected to the backing layer 94.

Each wire 112 is provided on the surface 91b of the base layer 91 and disposed between the base layer 91 and the lateral part 102. In short, each wire 112 is disposed on the lateral part 102. The plurality of wires 112 extend in substantially parallel in the lateral part 102.

Each of the plurality of wires 112 is electrically connected to, for example, the magnetic head 52, the LDU 53, the piezoelectric element, or the backing layer 94. At least one of the plurality of wires 112 may be floating.

As illustrated in FIG. 5, each of the plurality of joint terminals 67 is in the form of a simply supported beam (with both ends fixed), extending in substantially the X directions across the cover groove 105 between one of the wires 111 and one of the wires 112. Each of the plurality of joint terminals 67 thus extends in substantially the X directions between the two lateral parts 101 and 102.

As illustrated in FIG. 6, each of the plurality of joint terminals 67 has two surfaces 67a and 67b. The surface 67a is substantially flat and oriented in substantially the +Z direction. The surface 67b is opposite to the surface 67a and oriented in substantially the −Z direction. In the present embodiment, the surfaces 67a and 67b are with no holes and continuous between the two lateral parts 101 and 102. Alternatively, the joint terminal 67 may be provided with a hole that is open to the surfaces 67a and 67b.

As illustrated in FIG. 5, each of the plurality of joint terminals 67 further includes a pair of edges 121 and 122. One of the two edges 121 and 122 is an example of a first edge, whereas the other of the two edges 121 and 122 is an example of a second edge.

The edge 121 is located on the +Y-directional side of the joint terminal 67. The edge 122 is located on the −Y-directional side of the joint terminal 67. In short, the pair of edges 121 and 122 are opposite to each other. Each of the surfaces 67a and 67b expands between the pair of edges 121 and 122.

The plurality of joint terminals 67 are arranged at intervals in the Y directions. Thus, the edge 121 of one joint terminal 67 and the edge 122 of an adjacent joint terminal 67 face each other.

The edge 121 has a straight edge 125 and a recessed edge 126. The straight edge 125 is an example of a first straight edge. The recessed edge 126 is an example of a first recessed edge. The straight edge 125 extends linearly in substantially the X directions. The recessed edge 126 is recessed in the −Y direction from the straight edge 125. The recessed edge 126 thus forms a recess (depression).

The edge 122 has a straight edge 127 and a recessed edge 128. The straight edge 127 is an example of a second straight edge. The recessed edge 128 is an example of a second recessed edge. The straight edge 127 extends linearly in substantially the X directions. The recessed edge 128 is recessed in the +Y direction from the straight edge 127. Thus, the recessed edge 128 forms a recess (depression).

Each of the recessed edges 126 and 128 is a semicircular edge. However, the recessed edges 126 and 128 are not limited to this example. Alternatively, each of the recessed edges 126 and 128 may have an arc shape smaller than or larger than a semicircular shape, or may be a semi-elliptical edge, a rectangular edge, a triangular edge, or any other geometric edge.

The recessed edge 128 is closer to the lateral part 101 than the recessed edge 126 is. The recessed edge 128 is farther from the lateral part 102 than the recessed edge 126 is. In short, the two recessed edges 126 and 128 are provided at different positions in the Y directions.

In the present embodiment, the two edges 121 and 122 are point-symmetric to each other. Thus, the recessed edge 126 and the recessed edge 128 have substantially the same shape and size. However, the shapes of the edges 121 and 122 are not limited to these examples.

In the present embodiment, as illustrated in FIG. 4, a length Lc of each tail joint 66 in the Y directions is 9.0 to 10.0 mm, for example. A length (width) Wc of each tail joint 66 in the X directions is 0.7 to 0.9 mm, for example.

A length Ls of each of the cover groove 105 and a base groove 135 in the Y directions is 6.0 to 7.0 mm, for example. In the present embodiment, for example, 14 joint terminals 67 traverse the cover groove 105.

As illustrated in FIG. 5, a length Lt of the joint terminals 67 in the X directions is 0.24 to 0.32 mm, for example. The length Lt is substantially equal to a distance between the edge 101a of the lateral part 101 and the edge 102a of the lateral part 102.

A length (width) Wt of the joint terminals 67 in the Y directions is 0.16 to 0.24 mm, for example. The width Wt refers to a distance between the straight edges 125 and the straight edges 127 in the Y directions.

A length Ld of each of the recessed edges 126 and the recessed edges 128 in the X directions is 0.08 to 0.12 mm. In the X directions, the length of the straight edges 125 is equal to or larger than the length of the recessed edges 126, whereas the length of the straight edges 127 is equal to or longer than the length of the recessed edges 128. In the X directions, for example, the length Ld of the recessed edges 126 is 25 to 50% of the length (length Lt) of the edges 121, whereas the length Ld of the recessed edges 128 is 25 to 50% of the length (length Lt) of the edges 122.

A length (depth) Dd of each of the recessed edges 126 and the recessed edges 128 in the Y directions is 0.04 to 0.06 mm. In the Y directions, the depth Dd of the recessed edges 126 is 15 to 40% of the width Wt, whereas the depth Dd of the recessed edges 128 is 15 to 40% of the width Wt.

The lengths Lc, Ls, Lt, and Ld, the widths Wc and Wt, the depth Dd, and the number of the joint terminals 67 are merely examples and not limited to the above examples. For example, the number of the joint terminals 67 may increase with an increase in the functions of the HGA 36.

In one of the joint terminals 67, the straight edge 125 is opposite to the recessed edge 128. Likewise, the straight edge 127 is opposite to the recessed edge 126. The straight edge 125 of one joint terminal 67 faces the recessed edge 128 of an adjacent joint terminal 67. Likewise, the straight edge 127 of one joint terminal 67 faces the recessed edge 126 of an adjacent joint terminal 67.

An interval P between two adjacent joint terminals 67 is longer than the width Wt of the joint terminal 67. The interval P refers to a distance between the straight edge 125 of an edge 121 and the straight edge 127 of an edge 122 that faces the edge 121 in the Y directions.

As illustrated in FIG. 4, for example, the intervals between every two adjacent joint terminals 67 may be non-constant. In the present embodiment, the interval P between the two closest joint terminals 67 is at least 0.4 to 0.5 mm, for example. However, the interval P is not limited to this example.

The base layer 91 at each tail joint 66 has a substantially rectangular frame shape. The base layer 91 has two lateral parts 131 and 132 and two ends 133 and 134. The lateral part 131 is an example of a first base-layer part. The lateral part 132 is an example of a second base-layer part.

Each of the lateral parts 131 and 132 extends in substantially the Y directions. The lateral part 131 covers the lateral part 101 of the cover layer 92 and the plurality of wires 111. The lateral part 132 covers the lateral part 102 of the cover layer 92 and the plurality of wires 112. The lateral part 132 is thus apart from the lateral part 131 in the +X direction.

The end 133 is connected to the +Y-directional ends of the lateral parts 131 and 132. The end 133 covers the end 103 of the cover layer 92 and the plurality of wires 111 and 112 disposed on the end 103.

The end 134 is connected to the −Y-directional ends of the lateral parts 131 and 132. The end 134 is thus apart from the end 133 in the −Y direction. The end 134 covers the end 104 of the cover layer 92 and the plurality of wires 111 and 112 disposed on the end 104.

The base layer 91 is provided with the base groove 135. The base groove 135 is an example of a second groove. The base groove 135 is a through-hole passing the base layer 91 in substantially the Z directions. However, the base groove 135 is not limited to this example and may be a cutout, for example.

The base groove 135 is defined by the lateral parts 131 and 132 and the ends 133 and 134, for example. The base groove 135 is thus located between the two lateral parts 131 and 132 and between the two ends 133 and 134. The base groove 135 extends in substantially the Y directions.

The base groove 135 communicates with the cover groove 105. Through both the cover groove 105 and the base groove 135, the plurality of joint terminals 67 are exposed. In short, the plurality of joint terminals 67 are part of the conductive layer 93 exposed through both the cover groove 105 and the base groove 135, and form respective flying leads. However, the joint terminals 67 are not limited to this example.

As illustrated in FIG. 5, the lateral part 131 has an edge 131a. The edge 131a is provided at the +X-directional edge of the lateral part 131 and extends in substantially the Y directions. The lateral part 132 has an edge 132a. The edge 132a is provided at the −X-directional edge of the lateral part 132 and extends in substantially the Y directions. Both the edge 131a and the edge 132a face each other to define the base groove 135.

In each tail joint 66, the backing layer 94 has a substantially rectangular frame shape. The backing layer 94 is provided with a through-hole 141. The through-hole 141 is formed in substantially the Z directions across the backing layer 94 so as to communicate with the base groove 135. The through-hole 141 is larger than the base groove 135. Via the through-hole 141, the joint terminals 67 are exposed.

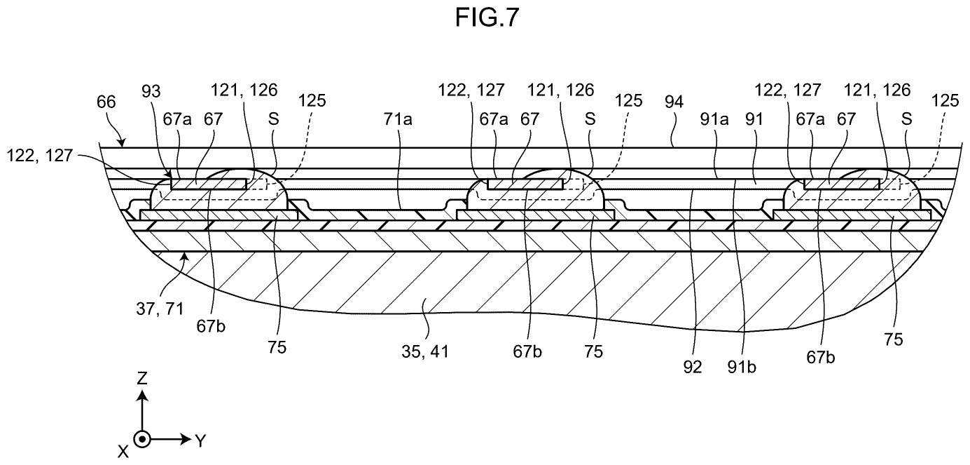

FIG. 7 is an exemplary cross-sectional view illustrating the tail joint 66 and the joint 71 in the first embodiment taken along line F7-F7 in FIG. 5. As illustrated in FIG. 7, the solder S adheres to the pads 75 of the joint 71. Furthermore, the solder S adheres to the surfaces 67b of the joint terminals 67 and adheres to at least part of edges 121 and 122 and surface 67a. The solder S thereby joins the joint terminals 67 to the corresponding pads 75.

As illustrated in FIG. 5, many wires 111 are 112 are provided at the tail joint 66. By making the conductive layer 93 thinner, the width of the wires 111 and 112 can also be made smaller, so that a larger number of wires 111 and 112 can be provided in the tail joint 66. For example, the thickness of the conductive layer 93 is set to 8μm or less. However, the thickness of the conductive layer 93 is not limited to this example. As described above, each joint terminal 67 forms the flying lead. Thus, by making the conductive layer 93 thinner, the joint terminal 67 is also made thinner.

As described above, each LDU 53 is electrically connected to the wires 111. In some cases, other conductors are interposed between each LDU 53 and the wires 111. For example, a part of the backing layer 94 may be separated from the rest thereof to partly form an electrical route between each LDU 53 and the wires 111.

For example, a part (referred to below as a relay) of the backing layer 94 is removed from the rest and is in the form of wiring. One end of the relay is electrically connected to a wire 111, for example, via a through-hole provided in the base layer 91. The other end of the relay is provided with, for example, a gold plating layer. The electrode of an LDU 53 is soldered to the gold plating layer. As a result, the LDU 53 is electrically connected to the wire 111 through the solder, the gold plating layer, the relay, and the through-hole. In this case, other conductors may be interposed between the LDU 53 and the wire 111, or the electrode of the LDU 53 may be soldered to the wire 111.

As described above, the gold plating layer may be provided on the backing layer 94. When the gold plating layer is provided on the backing layer 94, areas of the flexure 56 in which the gold plating is not to be formed are temporarily covered with a resist. Therefore, the plurality of joint terminals 67 are also temporarily covered with the resist.

When the resist is deformed due to thermal expansion thereof or when the resist is removed, for example, stress may be applied to the joint terminals 67. However, each joint terminal 67 is provided with no holes. In addition, the two recessed edges 126 and 128 are provided at different positions in the Y directions. As a result, the joint terminal 67 can maintain at least a predetermined width, thereby preventing the durability thereof from being lowered. It is therefore possible to prevent the joint terminals 67 from being damaged due to deformation of the resist or upon removal thereof.

To inspect the flexures 56, for example, probes may be brought into contact with the joint terminals 67. In this case, any damage to the joint terminals 67 by the probes can be prevented because each joint terminal 67 has at least a predetermined width and durability, as described above.

In manufacturing the plurality of flexures 56, a single sheet including the plurality of flexures 56 is formed. This sheet is wound into a roll form and expanded from both sides. In this case, for example, the flexures 56 are expanded in directions along the surfaces 91a and 91b of the base layers 91.

When the flexures 56 are expanded, the joint terminals 67, which have a thin shape, are also expanded in the directions along the surfaces 91a and 91b. However, damage to the joint terminals 67 can be prevented because each joint terminal 67 has at least a predetermined width and durability, as described above.

In manufacturing each HGA 36, for example, the solder S in paste form is applied to the individual pads 75 with printing, after which the tail joints 66 are disposed on the respective rows of the pads 75. The plurality of tail joints 66 are then irradiated with laser light, so that the solder S is molten and wet-spread over the surfaces 67a of the joint terminals 67.

The molten solder S adheres to the two edges 121 and 122 of each joint terminal 67. The solder S is wet-spread to the surfaces 67a beyond the recessed edges 126 and 128 provided at the edges 121 and 122. In this way, the solder S can adhere to the two surfaces 67a and 67b even if the joint terminals 67 are provided with no holes.

The solder S which has adhered to a recessed edge 126 is apart from the solder S which has adhered to the straight edge 127 of an adjacent joint terminal 67. Likewise, the solder S which has adhered to a recessed edge 128 is apart from the solder S which has adhered to the straight edge 125 of an adjacent joint terminal 67. It is therefore possible to prevent an adjacent pair of joint terminals 67 from being short-circuited by the solder S even if the joint terminals 67 are provided with no holes.

In the HDD 10 according to the first embodiment described above, each HGA 36 includes the magnetic head 52; and the flexure 56. The flexure 56 includes the gimbal 65 on which the magnetic head 52 is mounted; and a tail joint 66 electrically connected to the gimbal 65. The tail joint 66 includes the base layer 91 having an insulating property; the cover layer 92 having an insulating property; the conductive layer 93 disposed between the base layer 91 and the cover layer 92; and the backing layer 94 attached to the base layer 91. The cover layer 92 includes the lateral part 101; and the lateral part 102 apart from the lateral part 101. The cover groove 105 extends between the lateral part 101 and the lateral part 102. The conductive layer 93 includes the plurality of joint terminals 67 which are arranged at intervals and each of which extends across the cover groove 105 between the lateral parts 101 and 102. Each of the plurality of joint terminals 67 includes the edge 121 that faces an adjacent one of the plurality of joint terminals 67; and the edge 122 opposite to the edge 121. The edge 121 includes the straight edge 125 that extends linearly; and a recessed edge 126 that is recessed from the straight edge 125. The edge 122 includes the straight edge 127 that extends linearly; and a recessed edge 128 that is recessed from the straight edge 127. The recessed edge 128 is closer to the lateral part 101 than the recessed edge 126 is and farther from the lateral part 102 than the recessed edge 126 is.

When soldering a joint terminal 67 to a corresponding pad 75, for example, the molten solder S adheres to the surface 67b of the joint terminal 67 and flows to both the edge 121 and the edge 122. Due to the edge 121 having the recessed edge 126, a larger amount of solder S adheres to the recessed edge 126 than to the straight edge 125. Likewise, due to the edge 122 having the recessed edge 128, a larger amount of solder S adheres to the recessed edge 128 than to the straight edge 127. The solder S flows from both the recessed edge 126 and the recessed edge 128 to the surface 67a of the joint terminal 67, and adhere to both the two surfaces 67a and 67b of the joint terminal 67. In this manner, in each HGA 36 in the present embodiment, the plurality of joint terminals 67 can be firmly soldered to, for example, the respective pads 75.

The recessed edges 126 and 128 are farther from the adjacent joint terminals 67 than the straight edges 125 and 127 are. Furthermore, the molten solder S flows to the surface 67a of the joint terminal 67 through the recessed edges 126 and 128 so that it is less likely to flow toward the adjacent joint terminals 67. Because of this, in the HGA 36 in the present embodiment, the molten solder S is less likely to flow close to the adjacent joint terminals 67, resulting in preventing or reducing occurrence of short-circuit of the joint terminals 67.

The recessed edges 126 and 128 are disposed at substantially different locations in the longitudinal direction (X directions) of the joint terminal 67. In other words, the recessed edge 126 and the recessed edge 128 are not aligned with each other in the longitudinal direction of the joint terminal 67. Thus, the recessed edges 126 and 128 are not to narrow each joint terminal 67, resulting in avoiding a decrease in the durability of the joint terminals 67. In the HGA 36 in the present embodiment, the plurality of joint terminals 67 can be avoided from being damaged in the situations, such as during manufacture, at the time of a probing inspection, or in the event of a resist thermal expansion or a resist removal in the plating process.

The straight edge 125 faces the recessed edge 128 of an adjacent one of the plurality of joint terminals 67. The straight edge 127 faces the recessed edge 126 of another adjacent one of the plurality of joint terminals 67. Because of this, the fillets of solder S having adhered to two adjacent joint terminals 67 are less likely to be joined together than when straight edges 125 and straight edges 127 face each other. As a result, in the HGA 36 in the present embodiment, the molten solder S is unlikely to flow close to the adjacent joint terminals 67, resulting in preventing or reducing occurrence of short-circuit of the joint terminals 67.

Each of the plurality of joint terminals 67 has the surfaces 67a and 67b with no holes. Each of the surfaces 67a and 67b expands between the edge 121 and the edge 122. As such, without any holes, each joint terminal 67 can be avoided from being partly narrowed and lowered in durability. In addition, the joint terminal 67 can be prevented from being damaged, for example, by expansion of a resist inside such holes, which would otherwise occur to the joint terminal 67 with holed surfaces. The molten solder S can flow from the surface 67b to the opposite surface 67a through the recessed edges 126 and 128 of the joint terminal 67. As a result, in each HGA 36 in the present embodiment, the plurality of joint terminals 67 can be firmly soldered to, for example, the respective pads 75.

The edge 121 and the edge 122 are point-symmetric to each other. As such, in the HGA 36 in the present embodiment, for example, each joint terminal 67 can have substantially uniform strength and the solder S can be distributed in a balanced manner in the longitudinal direction of the joint terminal 67. This leads to prevention of a decrease in durability of each joint terminal 67.

The base layer 91 is colored to be able to absorb visible light. Thus, when the tail joints 66 are irradiated with laser light with the solder S adhering to the joint terminals 67, the base layer 91 is heated by absorbing the laser light. Heat transfer from the base layer 91 to the joint terminals 67 causes the joint terminals 67 to be heated and melt the solder S. As a result, the solder S can be efficiently molten in the HGAs 36 in the present embodiment.

Each of the recessed edges 126 and 128 has a semicircular shape. Such semicircular recessed edges 126 and 128 can work to decrease the concentration of stress on each joint terminal 67 more than the recessed edges 126 and 127 of a rectangular shape. Also, each joint terminal 67 can be less narrowed by the semicircular recessed edges 126 and 128 than the recessed edges 126 and 128 of a rectangular shape.

### Second Embodiment

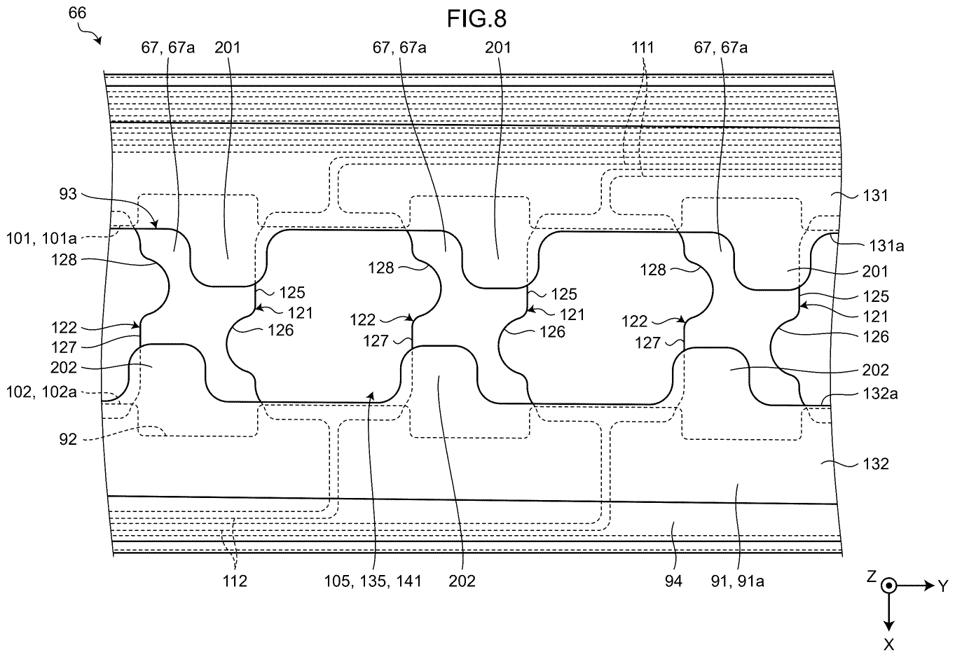

A second embodiment will be described below with reference to FIG. 8. In the following description of a plurality of embodiments, components having functions similar to those of the components that have already been described are denoted by the same reference numerals as those of the described components, and the description thereof may be omitted. Moreover, a plurality of components denoted by the same reference numerals do not necessarily have common functions and properties and may have different functions and properties in accordance with individual embodiments.

FIG. 8 is an exemplary plan view illustrating a part of a tail joint 66 according to the second embodiment. As illustrated in FIG. 8, a base layer 91 in the second embodiment further includes a plurality of projecting parts 201 and a plurality of projecting part 202. Each projecting part 201 is an example of a first projecting part. Each projecting part 202 is an example of a second projecting part.

The plurality of projecting parts 201 protrude in substantially the +X direction from an edge 131a of a lateral part 131 toward a lateral part 132. In the X directions, the length of the projecting parts 201 is smaller than the length (width) of a base groove 135. The projecting parts 201 are thus apart from the lateral part 132.

The plurality of projecting parts 202 protrude in the substantially −X direction from an edge 132a of the lateral part 132 toward the lateral part 131. In the X directions, the length of the projecting parts 202 is smaller than the length (width) of the base groove 135. The projecting parts 202 are apart from the lateral part 131 and the projecting parts 201.

A surface 67a of each of a plurality of joint terminals 67 is partly covered with one of the plurality of projecting parts 201. A part of the projecting part 201 protrudes beyond a straight edge 125 toward an adjacent joint terminal 67. In short, the projecting parts 201 cover the corresponding straight edges 125. However, the projecting parts 201 may not cover the straight edges 125.

The surface 67a of each of the plurality of joint terminals 67 is partly covered with one of the plurality of projecting parts 202. A part of the projecting part 202 protrudes beyond the straight edge 127 toward an adjacent joint terminal 67. In short, the projecting parts 202 cover the corresponding straight edges 127. However, the projecting parts 202 may not cover the straight edges 127.

The base layer 91 including the projecting parts 201 and 202 is apart from both the recessed edges 126 and 128. The base layer 91 is also apart from parts of the surfaces 67a near the recessed edges 126 and 128.

Similar to the first embodiment, molten solder S adheres to two edges 121 and 122 of each joint terminal 67. Since the base layer 91 is apart from the parts of the surfaces 67a near the recessed edges 126 and 128, the solder S can wet-spread to the surfaces 67a beyond the recessed edges 126 and 128 provided in the edges 121 and 122.

In an HDD 10 in the second embodiment described above, the base layer 91 is apart from both the recessed edges 126 and 128 and partly covers the plurality of joint terminals 67. As such, in the HGA 36 in the present embodiment, the plurality of joint terminals 67 can be reinforced by the base layer 91.

The base layer 91 includes the lateral part 131; the lateral part 132 apart from the lateral part 131; a plurality of projecting parts 201 protruding from the lateral part 131; and a plurality of projecting parts 202 being apart from the plurality of projecting parts 201 and protruding from the lateral part 132. The base groove 135 extends between the lateral part 131 and the lateral part 132, in communication with a cover groove 105. Each of the plurality of joint terminals 67 is partly covered with one of the plurality of projecting parts 201 and one of the plurality of projecting parts 202. With such an arrangement, in the HGA 36 in the present embodiment, the plurality of joint terminals 67 can be reinforced by the projecting parts 201 and 202 of the base layer 91. According to the HGA 36 of the present embodiment, for example, having the mutually separated projecting parts 201 and projecting parts 202 can eliminate the necessity for the base layer 91 to have thinner parts to connect the projecting part 201 and the projecting part 202 on the joint terminal 67. This makes it possible to facilitate the design of the base layer 91 even for the joint terminals 67 of a narrower width in the HGA 36 of the present embodiment.

### Third Embodiment

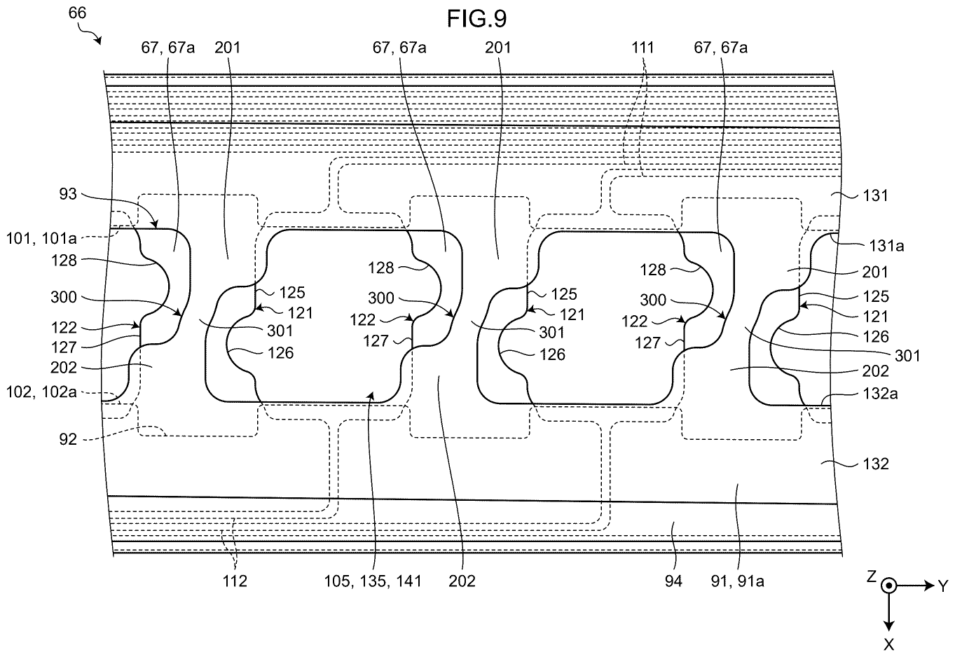

A third embodiment will be described below with reference to FIG. 9. FIG. 9 is an exemplary plan view illustrating a part of a tail joint 66 according to the third embodiment. As illustrated in FIG. 9, a base layer 91 in the third embodiment further includes a plurality of intermediate parts 300.

Each of the plurality of intermediate parts 300 includes a projecting part 201, a projecting part 202, and a connecting part 301. The projecting parts 201 and 202 are substantially the same as the projecting parts 201 and 202 in the second embodiment. Each connecting part 301 extends along the surface 67a of the joint terminal 67 to connect the projecting part 201 and the projecting part 202. Thus, each intermediate part 300 extends between the lateral part 131 and the lateral part 132 of the base layer 91. Each of the plurality of joint terminals 67 is partly covered with one of the plurality of intermediate parts 300.

In the Y directions, the length (width) of the connecting parts 301 is smaller than a width Wt of the joint terminals 67. In the Y directions, the width of the connecting parts 301 is smaller than the length (width) of the projecting parts 201 and smaller than the length (width) of the projecting parts 202. The connecting parts 301 are apart from the two edges 121 and 122.

In an HDD 10 according to the third embodiment described above, each base layer 91 includes the lateral part 131; the lateral part 132 apart from the lateral part 131; and the plurality of intermediate parts 300 each of which extends between the lateral part 131 and the lateral part 132. The base groove 135 extends between the lateral part 131 and the lateral part 132, in communication with a cover groove 105. Each of the plurality of joint terminals 67 is partly covered with one of the plurality of intermediate parts 300. As such, in each HGA 36 in the present embodiment, the plurality of joint terminals 67 can be reinforced by the intermediate parts 300 of the base layer 91. The intermediate parts 300 being continuous between the lateral part 131 and the lateral part 132 can reinforce the joint terminals 67 substantially uniformly in the longitudinal direction of the joint terminals 67.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A suspension assembly comprising:
a magnetic head; and
a wiring member including
a mount on which the magnetic head is mounted, and a tail joint electrically connected to the mount, wherein
the tail joint includes
a base layer having an insulating property,
a cover layer having an insulating property,
a conductive layer disposed between the base layer and the cover layer, and
a backing layer attached to the base layer,
the cover layer includes a first cover-layer part, a second cover-layer part being apart from the first cover-layer part, and a first groove extending between the first cover-layer part and the second cover-layer part,
the conductive layer includes a plurality of joint terminals which are arranged at intervals and each of which extends across the first groove between the first cover-layer part and the second cover-layer part,
each of the plurality of joint terminals includes
a first edge that faces an adjacent one of the plurality of joint terminals, and
a second edge being opposite to the first edge,
the first edge includes
a first straight edge that extends linearly, and
a first recessed edge that is recessed from the first straight edge,
the second edge includes
a second straight edge that extends linearly, and
a second recessed edge that is recessed from the second straight edge, and
the second recessed edge is closer to the first cover-layer part than the first recessed edge is, and is farther from the second cover-layer part than the first recessed edge is.

2. The suspension assembly according to claim 1, wherein
the first straight edge faces the second recessed edge of an adjacent one of the plurality of joint terminals, and
the second straight edge faces the first recessed edge of another adjacent one of the plurality of joint terminals.

3. The suspension assembly according to claim 1, wherein
each of the plurality of joint terminals has a surface with no hole and expanding between the first edge and the second edge.

4. The suspension assembly according to claim 1, wherein
the first edge and the second edge are point-symmetric to each other.

5. The suspension assembly according to claim 1, wherein
the base layer is apart from both the first recessed edge and the second recessed edge and partly covers the plurality of joint terminals.

6. The suspension assembly according to claim 5, wherein
the base layer includes a first base-layer part,
a second base-layer part being apart from the first base-layer part,
a plurality of first projecting parts that protrude from the first base-layer part,
a plurality of second projecting parts being apart from the plurality of first projecting parts and protruding from the second base-layer part, and
a second groove extending between the first base-layer part and the second base-layer part, in communication with the first groove, and
each of the plurality of joint terminals is partly covered with one of the plurality of first projecting parts and one of the plurality of second projecting parts.

7. The suspension assembly according to claim 5, wherein
the base layer includes a first base-layer part,
a second base-layer part being apart from the first base-layer part,
a plurality of intermediate parts each of which extends between the first base-layer part and the second base-layer part, and
a second groove extending between the first base-layer part and the second base-layer part, in communication with the first groove, and
each of the plurality of joint terminals is partly covered with one of the plurality of intermediate parts.

8. The suspension assembly according to claim 5, wherein
the base layer is colored to be able to absorb visible light.

9. The suspension assembly according to claim 1, wherein
each of the first recessed edge and the second recessed edge has a semicircular shape.

10. The suspension assembly according to claim 1, wherein
a distance between the first cover-layer part and the second cover-layer part is 0.24 to 0.32 mm.

11. The suspension assembly according to claim 1, wherein
in a direction in which the plurality of joint terminals are arranged, a distance between the first straight edge and the second straight edge is 0.16 to 0.24 mm.

12. The suspension assembly according to claim 1, wherein
in a direction in which the plurality of joint terminals are arranged, a distance between the first straight edge of the first edge and the second straight edge of the second edge facing the first edge is 0.4 to 0.5 mm.

13. The suspension assembly according to claim 1, wherein
in a direction in which each of the plurality of joint terminals extends, each of the first recessed edge and the second recessed edge has a length of 0.08 to 0.12 mm.

14. The suspension assembly according to claim 1, wherein
in a direction in which the plurality of joint terminals are arranged, each of the first recessed edge and the second recessed edge has a length of 0.04 to 0.06 mm.

15. The suspension assembly according to claim 1, wherein
in a direction in which each of the plurality of joint terminals extends, the first recessed edge has a length of 25 to 50% of a length of the first edge, and the second recessed edge has a length of 25 to 50% of a length of the second edge.

16. The suspension assembly according to claim 1, wherein
in a direction in which the plurality of joint terminals are arranged, each of the first recessed edge and the second recessed edge has a length of 15 to 40% of a distance between the first straight edge and the second straight edge.

17. A disk device comprising:
the suspension assembly according to claim 1;
a magnetic disk;
a board provided with a plurality of pads; and
a plurality of fillets of solder that joins the plurality of joint terminals and the plurality of pads, wherein the magnetic head is configured to read and write information from and to the magnetic disk.
